(19) United States
(12) Patent Application Publication
(10) Pub. No.: US 2011/0303798 A1
(43) Pub. Date: Dec. 15, 2011

(54) WALL STORAGE MOUNTING SYSTEM

(75) Inventors: Devin P. Bader, Milwaukee, WI (US); Franco F. Daino, Muskego, WI (US); Tyler Steinhardt, Milwaukee, WI (US); Robert S. Fuller, West Bend, WI (US); Peter J. Heinen, Kewaskum, WI (US)

(73) Assignee: WATERLOO INDUSTRIES, INC., Oak Creek, WI (US)

(21) Appl. No.: 13/112,031

(22) Filed: May 20, 2011

Related U.S. Application Data
(63) Continuation-in-part of application No. 12/197,564, filed on Aug. 25, 2008.
(60) Provisional application No. 61/346,957, filed on May 21, 2010.

(51) Int. Cl. F16M 13/02; B23P 11/00; B23P 17/00; F16L 3/123

(52) U.S. Cl. 248/65; 211/94.02; 29/428; 29/525.01

(57) ABSTRACT

A wall-mountable slatwall system for use with one or more mounting components includes first and second rail members. The first rail member includes a wall engaging portion disposed on a rear side and a rearward oriented first hook portion disposed on a front side. The second rail member includes a wall engaging portion disposed on a rear side and a forward oriented second hook portion disposed along a first edge of a front side and pivotally receivable between the first hook portion and the wall engaging portion of the first rail member when the second rail member is assembled with the first rail member. The wall engaging portion of the first rail member obstructs lateral disengagement of the second hook portion from the first hook portion.

### CROSS-REFERENCE TO RELATED APPLICATIONS

This non-provisional application claims priority to, and any other benefit of, U.S. Provisional Patent Application Ser. No. 61/346,957, entitled “WALL STORAGE MOUNTING ARRANGEMENTS” and filed on May 21, 2010, the entire disclosure of which is fully incorporated herein by reference. This application is also a continuation-in-part of U.S. patent application Ser. No. 12/197,564, entitled “WALL STORAGE MOUNTING ARRANGEMENTS” and filed on Aug. 25, 2008, the entire disclosure of which is incorporated by reference herein, to the extent that it does not conflict with the present application.

### BACKGROUND

Use of available wall space for storage of items is often desirable, for example, where easy access to or visibility of these items is required, and/or where floor space is limited, such as for example, in a retail setting or in a residential garage. While some items may be stored or retained on a wall by a conventional peg board and hook arrangement, slatwall panels may also be used for more versatile storage options. A conventional slatwall panel includes one or more horizontal slots configured to receive hooks, fasteners, or other such components, for example, for direct retention of an item (e.g., a hand tool or article for retail sale). Additionally or alternatively, hooks or fasteners may be affixed to storage accessories, such as, for example, bins, cabinets, boxes, hangers, or shelves, for storage of one or more items.

### SUMMARY

According to an aspect of the present application, an exemplary wall-mountable slatwall system for use with one or more mounting components includes first and second rail members. The first rail member includes a wall engaging portion disposed on a rear side and a rearward oriented first hook portion disposed on a front side and vertically aligned with the wall engaging portion. The second rail member includes a wall engaging portion disposed on a rear side and a forward oriented second hook portion disposed along a first edge of a front side and pivotally receivable between the first hook portion and the wall engaging portion of the first rail member when the second rail member is assembled with the first rail member. The first rail member obstructs lateral disengagement of the second hook portion from the first hook portion.

According to another aspect of the present application, an exemplary method of preparing a wall mounted slatwall is described. A wall engaging portion on a rear side of a first rail member is secured to an external wall surface. A forward oriented second hook portion on a front side of a second rail member is engaged with a rearward oriented first hook portion on a front side of the first rail member. The second rail member is pivoted to engage a wall engaging portion of the second rail member with the external wall surface, such that the second hook portion is interlocked between the first hook portion and a hook retaining portion of the first rail member. At least one of the first and second rail members defines at least one slot portion disposed on the front side and configured to receive one or more mounting components for mounted retention of the one or more mounting components.

According to still another aspect of the present application, an exemplary slatwall mounting system for electrically powered components includes a rail member and an electrical wire retaining sleeve. The rail member includes first and second edges extending in a longitudinal direction between first and second ends. A rear side of the rail member is configured to engage an external wall surface. A front side of the rail member includes a first slot portion proximate the first edge and including an undercut extending away from the first edge, a second slot portion proximate the second edge and including an undercut extending away from the second edge, and a recess disposed between the first and second slot portions and extending between the first and second ends of the rail member. The electrical wire retaining sleeve is securely retained in the rail member recess. The sleeve includes a longitudinal seam disposed in a front portion of the sleeve, with at least a portion of the sleeve being flexible to permit spreading of the seam for extension of electrical wiring therethrough for connection with an electrically powered component mounted to the rail member.

### BRIEF DESCRIPTION OF THE DRAWINGS

Features and advantages of the invention will become apparent from the following detailed description made with reference to the accompanying drawings, wherein:

FIG. 1A illustrates a partial side schematic view of a wall storage mounting system or arrangement, according to an exemplary embodiment;

FIG. 1B illustrates a partial side schematic view of another wall storage mounting system, according to another exemplary embodiment;

FIG. 1C illustrates a partial front schematic view of a wall storage mounting system, according to another exemplary embodiment;

FIG. 2A illustrates a partial side schematic view of a wall storage mounting system, according to yet another exemplary embodiment;

FIG. 2B illustrates a partial side schematic view a wall storage mounting system, according to still another exemplary embodiment;

FIG. 3 illustrates a partial side schematic view of a wall storage mounting system with a movable retaining member, according to an exemplary embodiment;

FIG. 4 illustrates a partial side schematic view of a wall storage mounting system with a movable retaining member, according to another exemplary embodiment;

FIG. 5A illustrates a partial side schematic view of a wall storage mounting system with a fixed retaining portion and a movable retaining member, according to an exemplary embodiment;

FIG. 5B illustrates a partial side schematic view of a wall storage mounting system with first and second movable retaining members, according to an exemplary embodiment;

FIG. 6A illustrates a side view of a rail member, according to an exemplary embodiment;

FIG. 6B illustrates a front perspective view of the rail member of FIG. 6A;

FIG. 6C illustrates a side perspective view of the rail member of FIG. 6A assembled with a mounting system, shown in partial cross-section to illustrate additional features of the assembly;

FIG. 6D illustrates a side view of a slatwall panel assembly, according to an exemplary embodiment;

FIG. 7A illustrates a side view of a mounting bracket assembled with a rail member, according to an exemplary embodiment;

FIG. 7B illustrates a rear perspective view of the mounting bracket of FIG. 7A;

FIG. 7C illustrates a front perspective view of an adapter plate for use with the mounting bracket of FIG. 7A, according to an exemplary embodiment;

FIG. 7D illustrates a side cross-sectional view of the adapter plate of FIG. 7C assembled with the mounting bracket of FIG. 7A;

FIG. 7E illustrates a side view of a power strip mounted directly to a rail member, according to an exemplary embodiment;

FIG. 8A illustrates a side view of an extruded rail member, according to an exemplary embodiment;

FIG. 8B illustrates a side perspective view of the rail member of FIG. 8A;

FIG. 8C illustrates a side perspective view of an extruded rail member, according to another exemplary embodiment;

FIG. 9A illustrates a side perspective view of an extruded rail member, according to another exemplary embodiment;

FIG. 9B illustrates a side view of the rail member of FIG. 9A;

FIG. 9C illustrates a side perspective view of an extruded rail member, assembled with fastener cover plates, according to another exemplary embodiment;

FIG. 9D illustrates a side view of the rail member assembly of FIG. 9C;

FIG. 10A illustrates a side perspective view of a rail member, according to an exemplary embodiment;

FIG. 10B illustrates a side perspective view of an anchor rail member for use with the rail member of FIG. 10A, according to an exemplary embodiment;

FIG. 10C illustrates a side perspective view of a cover rail member for use with the rail member of FIG. 10A, according to an exemplary embodiment;

FIG. 10D illustrates a side view of a slatwall panel assembly including the rail member of FIG. 10A, the anchor rail member of FIG. 10B, and the cover rail member of FIG. 10C, according to an exemplary embodiment;

FIG. 10E illustrates a side view of the slatwall panel assembly of FIG. 10D;

FIG. 11A illustrates a perspective view of a left wall mount member for a rail member, according to an exemplary embodiment;

FIG. 11B illustrates a perspective view of a right wall mount member for a rail member, according to an exemplary embodiment;

FIG. 11C illustrates a perspective view of a joining member for rail members, according to an exemplary embodiment;

FIG. 11D illustrates a perspective view of first and second rail members assembled with left and right wall mount members and a joining member, according to an exemplary embodiment;

FIG. 12A illustrates an outer perspective view of a left cap member, according to an exemplary embodiment;

FIG. 12B illustrates an outer perspective view of a right cap member, according to an exemplary embodiment;

FIG. 12C illustrates an inner perspective view of the left cap member of FIG. 12A;

FIG. 12D illustrates an inner perspective view of the right cap member of FIG. 12B;

FIG. 12E illustrates a perspective view of a rail member assembled with left and right cap members, according to an exemplary embodiment;

FIG. 13A illustrates a perspective view of a left wall mount member adapted for assembly with a cap member, according to an exemplary embodiment;

FIG. 13B illustrates a perspective view of a right wall mount member adapted for assembly with a cap member, according to an exemplary embodiment;

FIG. 13C illustrates a perspective view of a joining member adapted for assembly with a cap member, according to an exemplary embodiment;

FIG. 13D illustrates a perspective view of a left cap member aligned for assembly with the left wall mount member of FIG. 13A, according to an exemplary embodiment;

FIG. 13E illustrates an end view of the cap member and wall mount member of FIG. 13D;

FIG. 14A illustrates a front perspective view of a rail member provided with a wiring sleeve and a mounting bracket, according to an exemplary embodiment;

FIG. 14B illustrates a front perspective view of a rail member provided with a wiring sleeve, end cap, and mounted power strip, with the end cap and wiring sleeve shown in phantom, according to an exemplary embodiment;

FIG. 14C illustrates a rear perspective view of the end cap of FIG. 14B;

FIG. 14D illustrates a front perspective view of a rail member provided with a wiring sleeve and a bracket mounted power strip, according to an exemplary embodiment; and

FIG. 14E illustrates a front perspective view of a rail member provided with a wiring sleeve and a bracket mounted lighting fixture, according to an exemplary embodiment.

### DETAILED DESCRIPTION

This Detailed Description describes exemplary embodiments of the present application and is not intended to limit the scope of the application in any way. Indeed, the invention is broader than and unlimited by the embodiments described herein, and the terms used in the claims and otherwise have their full ordinary meaning.

The present application relates to wall storage mounting systems or arrangements in which a slatwall, configured to be mounted to a wall or other surface, includes one or more slots for receiving hooks, fasteners, or other such hardware for retaining an item, such as, for example, a hand tool, or a storage accessory, such as, for example, a bin or cabinet. The slots of a slatwall may include one or more laterally extending undercuts or recesses configured to receive laterally extending portions of hooks, fasteners, brackets or other hardware, such that when the hardware receives and or supports an item to be retained on the slatwall, engagement of the laterally extending portion of the hardware with a portion of the slatwall secures the hardware and the item to the slatwall to prevent the hardware and item from separating from or falling off of the slatwall.

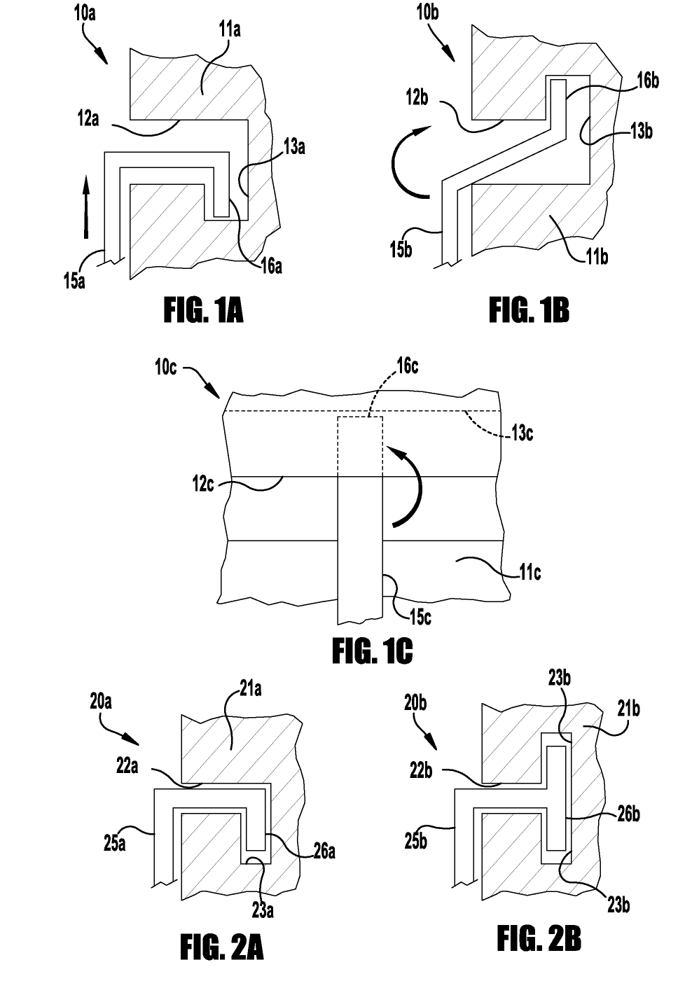

Schematic representations of some exemplary wall storage mounting arrangements 10a, 10b, 10c are illustrated in FIGS. 1A-1C, respectively. The wall storage arrangements include mounting members 15a, 15b, 15c (such as, for example, brackets or other such hardware) having retaining portions 16a, 16b, 16c (such as, for example, hooks, tabs, and/or flanges, or other such projections) that may be inserted into slots 12a, 12b, 12c in a slatwall 11a, 11b, 11c through the front openings of the slots, and then slid (FIG. 1A), pivoted (FIG. 1B), or rotated (FIG. 1C) into the undercut 13a, 13b, 13c of the slot for retention of the mounting member. While these arrangements may loosely support and secure the hardware and retained items against downward forces (e.g., the weight of the retained item), the hardware and retained item may be inadvertently separated from the slatwall by upward, outward, and/or lateral forces applied to the hardware and/or retained item, for example, due to bumping the item and/or hardware or during retrieval of an item from the hardware or storage accessory. The slatwall and mounting hardware may be provided with holes (not shown) configured to align and receive fasteners to more securely affix the hardware to the slatwall. However, such an system may limit the positions at which the hardware may be mounted, and may make adjustments to the wall storage system more inconvenient or time consuming.

In another embodiment, shown, for example, in FIGS. 2A and 2B, wall storage mounting arrangements 20a, 20b may include mounting members 25a, 25b provided with laterally extending portions 26a, 26b sized or shaped such that they cannot be inserted into, or removed from, the front openings of the slots 22a, 22b, thereby preventing the mounting member 25a, 25b from being inadvertently separated from the front of the slatwall 21a, 21b. To remove the mounting member from the slatwall, a user would have to slide the mounting member 25a, 25b along the length of the slot 22a, 22b and out of the slot, which may require removal of other hardware assembled with the same slot. To assemble the mounting member 25a, 25b with the slatwall 21a, 21b, the user would insert the laterally extending portions 26a, 26b into the undercuts 23a, 23b at an end of the slot and slide the mounting member to a desired position, which may also require removal of other hardware assembled with the same slot 22a, 22b.

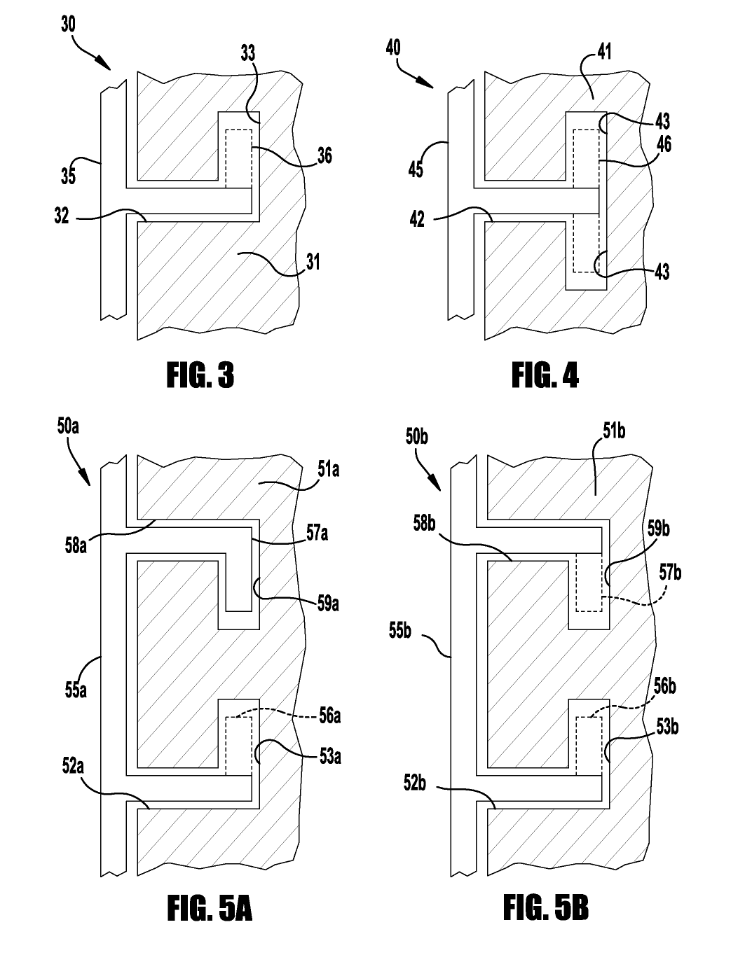

According to an inventive aspect of the present application, as schematically shown, for example, in FIG. 3, a wall storage mounting arrangement 30 may include a mounting member 35 (such as, for example, a bracket or other such hardware) having a movable retaining member (shown in phantom at 36) configured to be moved between a mounting member retaining position and a mounting member releasing position. In the retaining position, a portion of the retaining member engages a recess or undercut 33 in the slot 32 of the slatwall 31, such that withdrawal of the retaining member 36 through the front opening of the slot 32 is prohibited. In the releasing position, the retaining member 36 is moved or retracted out of engagement with the undercut 33 in the slot 32, thereby permitting withdrawal of the retaining member 36 from the slot 32, and separation of the mounting member 35 from the slatwall 31.

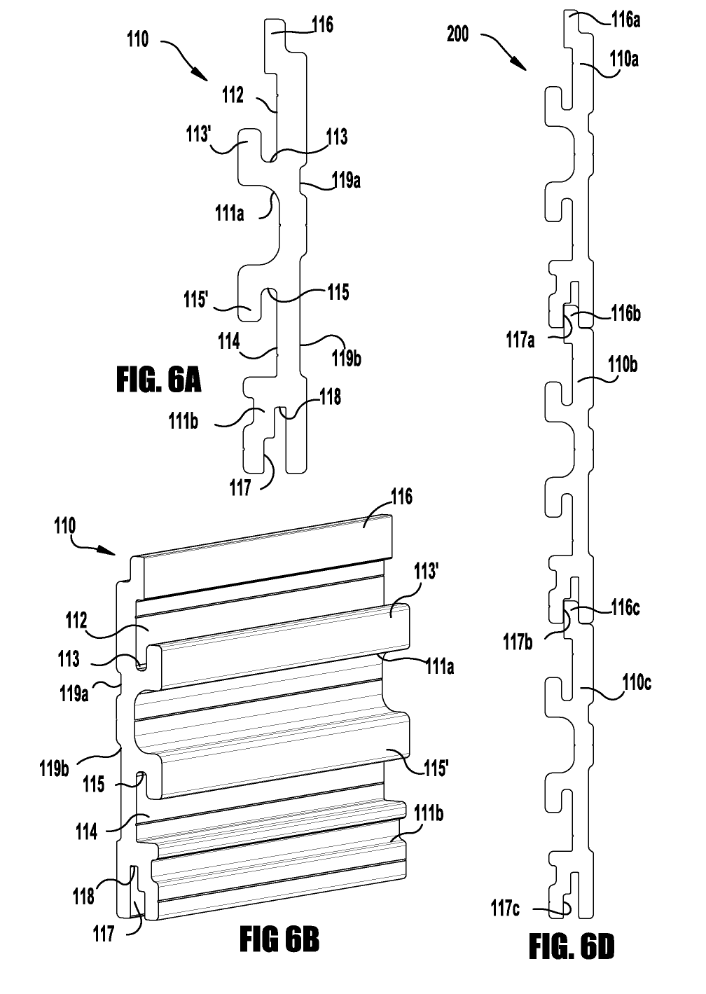

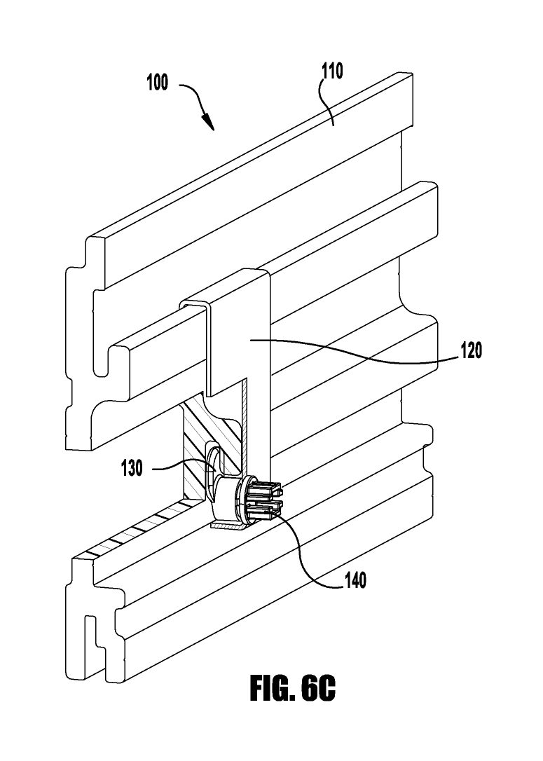

The movable retaining member 36 may be configured to be moved in and out of engagement with a single undercut 33, as shown in FIG. 3. In another embodiment, as shown in FIG. 4, a movable retaining member 46 may be moved in and out of engagement with multiple undercuts 43. Further, to provide additional support for a stored item or storage accessory, as shown in FIGS. 5A and 5B, a mounting member 55a, 55b having a movable retaining member 56a, 56b may include a second retaining portion 57a, 57b configured to engage an undercut 59a, 59b, of a second slot 58a, 58b. As shown in FIG. 5A, the second retaining portion 57a may include one or more fixed laterally extending projections (for example, hooks, tabs, or flanges). Additionally or alternatively, the second retaining portion 57b may include a second movable retaining member configured to be moved between a mounting member retaining position and a mounting member releasing position.

Many different mechanisms may be utilized to provide for movement of a movable retaining member between mounting member retaining and releasing positions, including, for example, sliding, pivoting, rotating, or extending mechanisms. In one embodiment, a movable retaining member is configured to be manipulable (either directly or indirectly) from an outer or front side of the mounting member, for example, between mounting member retaining and releasing positions. Examples of such mechanisms and configurations are described in co-pending U.S. patent application Ser. No. 12/197,564, entitled “WALL STORAGE MOUNTING ARRANGEMENTS” and filed on Aug. 25, 2008 (the “'564 Application”), the entire disclosure of which is incorporated by reference herein, to the extent that it does not conflict with the present application.

As described in the present application, a wall storage mounting system may include a plurality of rail members configured to be stacked with each other to provide a slatwall panel assembly having multiple slots for mounting items or storage accessories (for example, by using the cam locking bracket described in greater detail above) at multiple vertical and horizontal locations. Additionally, larger items or storage accessories may utilize slots on multiple rail members. In one embodiment, a rail member includes a vertically extending tongue at one end for insertion into a corresponding vertically extending groove of an adjacent rail member. Additionally or alternatively, the rail member may include a vertically extending groove at one end for receiving a vertically extending tongue of an adjacent slatwall member. The rail member may, but need not, be configured to interlockingly stack with other substantially identical rail members, thereby eliminating the need for production, storage, and inventory management of rail members of different configurations.

FIGS. 6A and 6B illustrate an exemplary rail member 110 having first and second slots 112, 114 with corresponding first and second undercuts 113, 115, as described in greater detail above. The rail member 110 includes a vertically extending tongue 116 at a first end and a vertically extending groove 117 at a second end. The groove 117 is sized to receive a tongue of another rail member, which may be consistent with or substantially match the tongue 116 of the illustrated rail member 110. The tongue 116 is sized to be inserted in a groove of another rail member, which may be consistent with or substantially match the groove 117 of the illustrated rail member 110. FIG. 6D illustrates an exemplary slatwall panel assembly 200 including first, second, and third rail members 110a, 110b, 110c interlockingly stacked to form the panel assembly 200. As shown, the interlocking tongues 116b, 116c and grooves 117a, 117b may be sized for a press fit interlocking engagement for holding the rail members 110a, 110b, 110c together, for example, for mounting to a wall or other such surface. As shown, the bracket engaging portions (slots 112, 114) may be symmetrically shaped with respect to each other, such that the rail members 110 may be stacked either with tongues 116 facing upward and grooves 117 facing downward, as shown in FIG. 6D, or with grooves 117 facing upward and tongues 116 facing downward. In the illustrated embodiment, the slots 112, 114 are substantially mirror image L-shapes in cross section, to accommodate many different types of mounting brackets and other such arrangements.

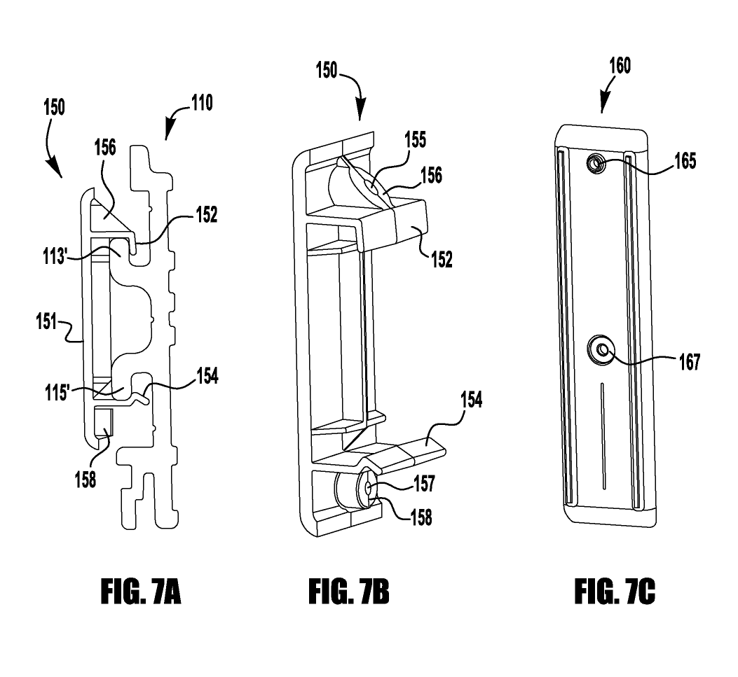

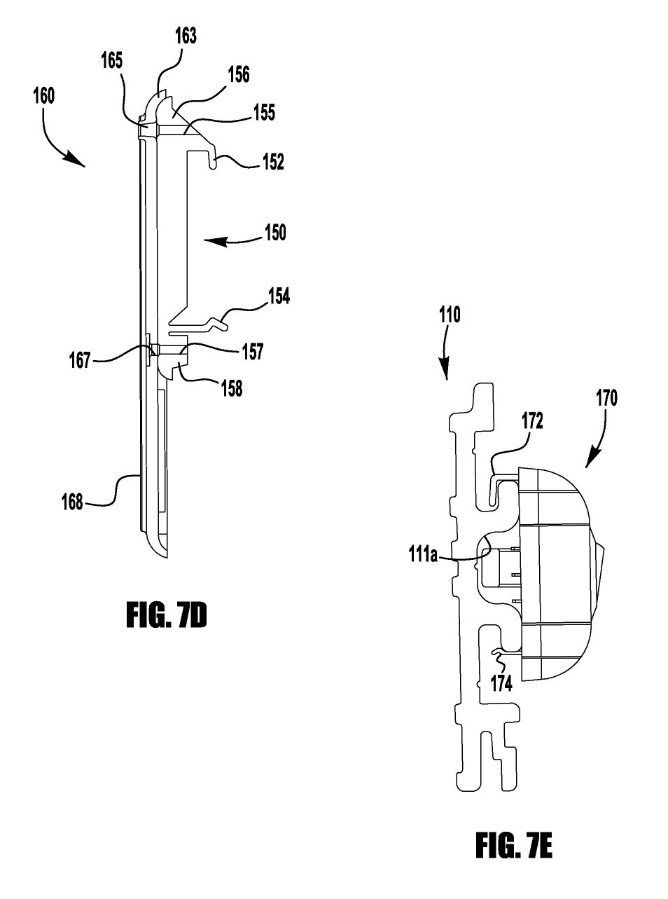

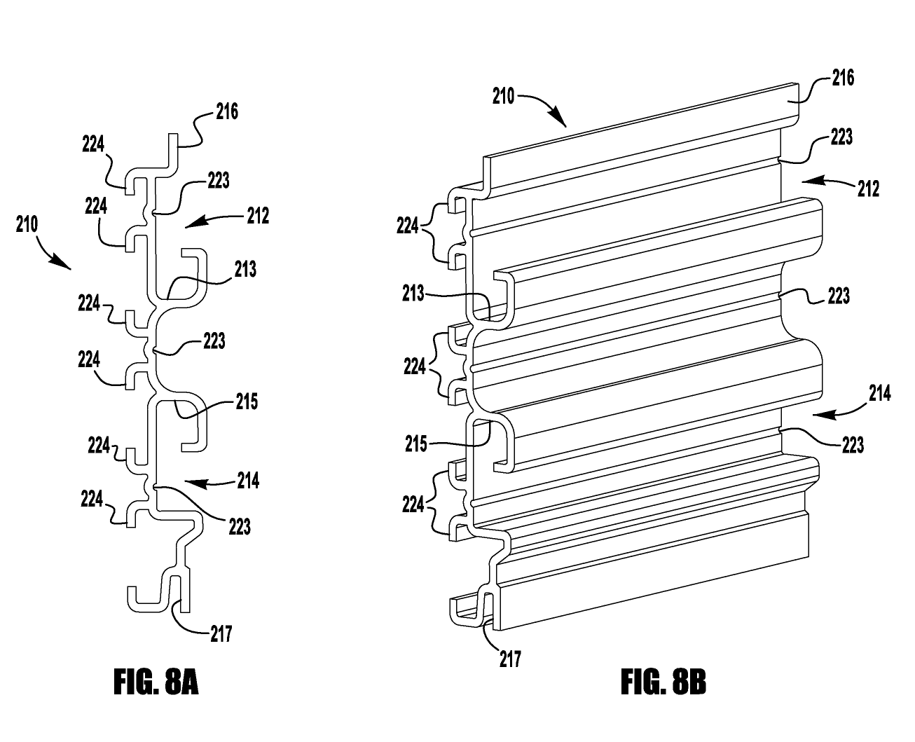

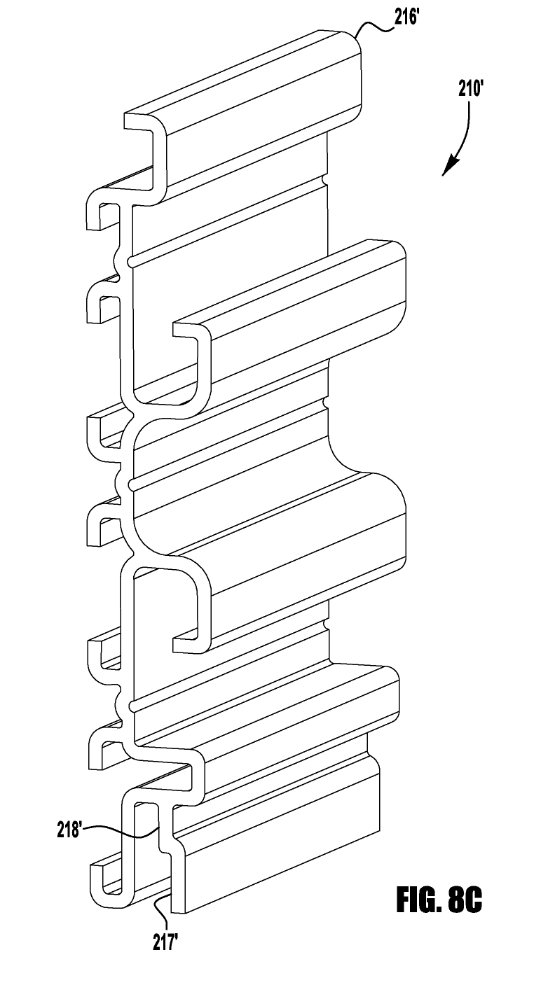

One exemplary mounting system includes a mounting bracket 120 with a downward oriented J-shaped retaining portion 122 and an upward oriented movable retaining member 130 assembled with the bracket 120, as shown in the embodiment of FIG. 6C and described in greater detail in the '564 Application. In another embodiment, as shown in FIGS. 7A and 7B, a mounting bracket 150 may be provided with a downward oriented J-shaped retaining portion 152 and an upward biased flexible gripping portion 154 configured to provide snap-fit engagement between the bracket 150 and overhang portions 113′, 115′ of the rail member 110 (or any other suitable rail member, including the other rail members described herein).

While the mounting bracket may be provided with many different mounting components, such as, for example, hooks, loops, hanging racks, and receptacles (not shown), in the exemplary embodiment of FIGS. 7A and 7B, the mounting bracket 150 includes mounting holes 155, 157 extending into bosses 156, 158 for directly or indirectly mounting any number of mounting components to a front surface 151 to adapt the mounting bracket 150 for use with any number of items to be mounted. As one example, the mounting holes 155, 157 may be threaded to receive bolts, machine screws or other fasteners (not shown) to mount an item provided with one or more keyhole-type or slotted mounting portions. Alternatively, thread cutting or forming screws (not shown) may be threaded into unthreaded mounting holes 155, 157.

As another example, an adapter plate may be secured to the mounting bracket to accommodate attachment with other items to be mounted (e.g., a battery charger). As one example, an item having mounting portions that are spaced apart by a dimension too large to be accommodated by the mounting bracket, may utilize an elongated extension plate or adapter plate provided with spaced apart locations for attachment of mounting portions on the item. As shown in FIGS. 7C and 7D, an adapter plate 160 may be provided with mounting holes 165, 167 that align with the mounting holes 155, 157 of the mounting bracket 150. In the illustrated embodiment, the lower mounting hole 167 is adapted to receive a fastener for attachment of the adapter plate 160 to the bracket 150 (with a counterbore for flush installation of the fastener). The upper mounting hole 165 is adapted to receive a mounting fastener affixed to or associated with the item to be mounted. As shown, the upper mounting hole 165 may be outwardly tapered to accommodate a fastener assembled directly to the underlying mounting hole 155 of the bracket 150. The illustrated adapter plate 160 also include an outer perimeter sidewall 163 that may be sized to closely receive the upper and side edges of the mounting bracket 150 to more securely retain the adapter plate 160 on the bracket 150. The adapter plate 160 also includes an extended region 168 for supporting a spaced apart mounting portion of an item to be mounted. While this extended region may be provided with one or more pre-formed mounting holes or other mounting portions, the illustrated embodiment includes a demarcation or slot 169 allowing for user placement of a mounting hole (e.g., by drilling) at a desired location for receiving the spaced apart mounting portion of the item to be mounted.

In still another embodiment, an item to be mounted (e.g., a power strip 170) may be provided with an integral downward oriented J-shaped retaining portion 172 and an upward biased flexible gripping portion 174 configured to provide snap-fit engagement with the rail member 110 (or any other suitable rail member), as shown in FIG. 7E and described in greater detail below. As shown, a recess 111a in the rail member 110 may receive a portion of the mounted item 170.

According to an inventive aspect of the present application, a rail member configured to interlockingly stack with similar or identical rail members may additionally be configured to stack with a panel, board, or other such component that is dimensionally different from the rail member. As shown in FIGS. 6A and 6B, the groove 117 may include a further extension or recess 118 sized to receive a portion of a differently dimensioned interlocking member (e.g., a significantly thinner interlocking member). As one example, a groove recess 118 may be sized to closely receive an end portion of a conventional peg board (not shown) or other such panel. For example, the groove recess 118 may be approximately ¼″ thick to receive a ¼″ thick peg board, or approximately ⅛″ thick to receive a ⅛″ thick peg board.

While a rail member may be constructed in any suitable material (for example, various metals and plastics), in one embodiment, the rail member 110 may be constructed from extruded polyvinyl chloride (PVC) material. To preserve material used to construct the rail member 110 while maintaining adequate strength of the rail component, recesses (shown, for example, at 111a, 111b, 119a, 119b) may be formed in the front and rear sides of the rail member 110.

In another embodiment, a rail member may be constructed from an extruded metal, such as, for example, aluminum. In one such embodiment, an extruded metal rail may provide mounting hardware interfacing surfaces consistent with those of a conventional plastic rail, while including a modified cross-sectional shape configured to facilitate extrusion and reduce material volume and weight.

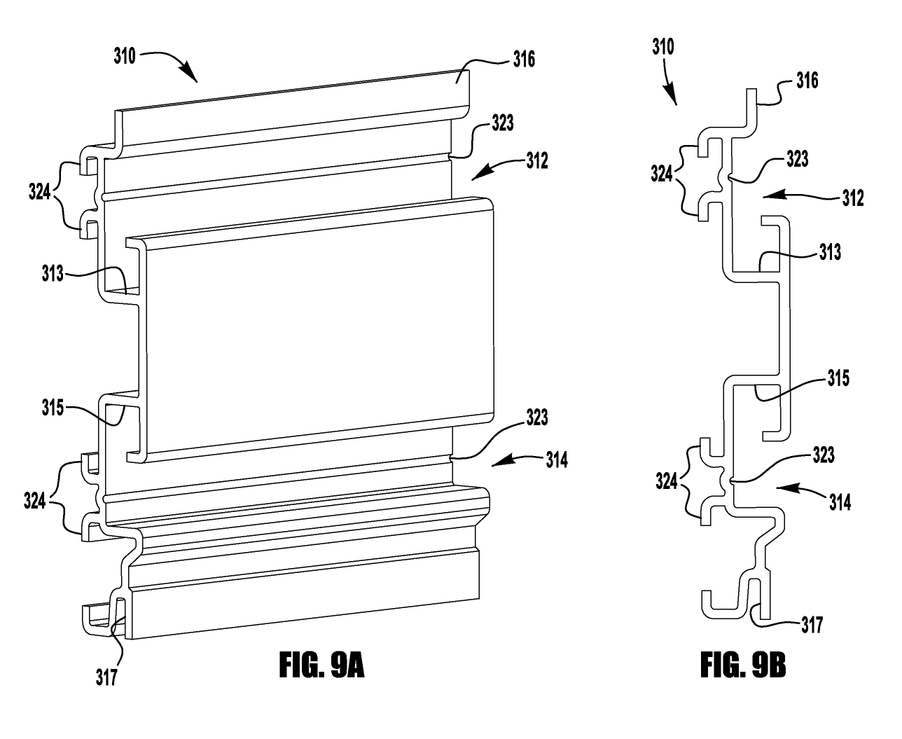

FIGS. 8A and 8B illustrate an exemplary embodiment of an extruded rail member 210 having first and second slots 212, 214 with corresponding first and second undercuts 213, 215, which may be consistent with the slots and undercuts of the rail member 110 of FIGS. 6A and 6B. The rail member 210 includes a vertically extending tongue 216 at a first end and a vertically extending groove 217 at a second end. The groove 217 is sized to receive a tongue of another rail member, which may be consistent with or substantially match the tongue 216 of the illustrated rail member 210. The tongue 216 is sized to be inserted in a groove of another rail member, which may be consistent with or substantially match the groove 217 of the illustrated rail member 210. The interlocking tongues 216 and grooves 217 may be sized for a press fit interlocking engagement for holding the rail members 210 together, for example, for mounting to a wall or other such surface. As shown, the bracket engaging portions (slots 212, 214) may be symmetrically shaped with respect to each other, such that the rail members 210 may be stacked either with tongues 216 facing upward and grooves 217 facing downward, or with grooves facing upward and tongues facing downward. In the illustrated embodiment, the slots 212, 214 are substantially mirror image L-shapes in cross section, to accommodate, for example, the mounting bracket 120 and retaining member 130 of FIG. 6C (described in greater detail in the '564 Application), and/or the mounting bracket 150 of FIG. 7A.

Still other features may be provided with the extruded rail member 210. For example, the rail member 210 may include one or more recesses or grooves 223 positioned to facilitate alignment of mounting fasteners used to affix the rail member 210 to a wall surface. As another example, the rail member 210 may be provided with one or more spacer flanges 224 extending from a rear side of the rail member 210 proximate to mounting locations on the rail member 210 (e.g., proximate to mounting grooves 223), for example, to provide resilient support for the mounted rail member 210.

As with the rail member 110 of FIGS. 6A and 6B, an extruded rail member 210′, as shown in FIG. 8C may include a groove 217′ having a further extension or recess 218′ sized to receive a portion of a differently dimensioned interlocking member (e.g., a significantly thinner interlocking member). As one example, a groove recess 218′ may be sized to closely receive an end portion of a conventional peg board (not shown) or other such panel. For example, the groove recess 218′ may be approximately ¼″ thick to receive a ¼″ thick peg board, or approximately ⅛″ thick to receive a ⅛″ thick peg board.

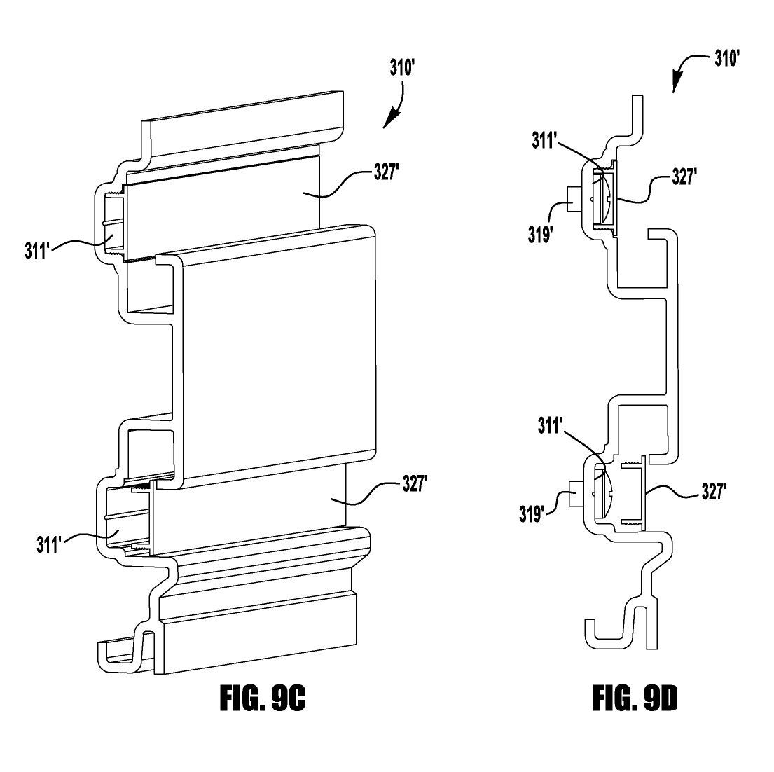

Still other extruded rail member configurations may be utilized. FIGS. 9A and 9B illustrate another extruded rail member 310. While the exemplary rail member 310 has a different cross-sectional shape than the rail member 210 of FIGS. 8A and 8B (shown, for example, with a flat front surface between slots 312, 314), the rail member 310 may still include similar first and second slots 312, 314 and corresponding first and second undercuts 313, 315, vertically extending tongue 316 and groove 317, recesses or grooves 323 positioned to facilitate alignment of mounting fasteners, and spacer flanges 324 extending from a rear side of the rail member 310 proximate to the mounting locations.

As shown in FIGS. 9C and 9D, a rail member 310′ may also be provided with fastener cover panels 327′, which may be press fit into mounting recesses 311′ in the rail member 310′ to cover the mounting fasteners 319′ and provide a more uniform appearance.

While rail members may be configured to be stacked by vertically engaging tongue and groove arrangements, as discussed above, other stacking and mounting arrangements may additionally or alternatively be utilized. In one embodiment, a slatwall panel or rail member may be configured to utilize an interlocking arrangement to mount the rail member and/or to stack two or more rail members to produce a slatwall panel assembly having multiple slots for mounting items or storage accessories. The rail members may interlock, for example, by pivoting or horizontal sliding engagement between corresponding interlocking portions of the rail members. In one such example, interlocked engagement of the stacked rail members may provide for overlap of a fastened portion of a rail member by a second, stacked rail member. This overlap may cover mounting fasteners and/or produce a seamless appearance between the stacked rail members. Further, the interlock between the stacked rail members may brace the rail members against perpendicular horizontal or lateral movement and against vertical movement with respect to each other.

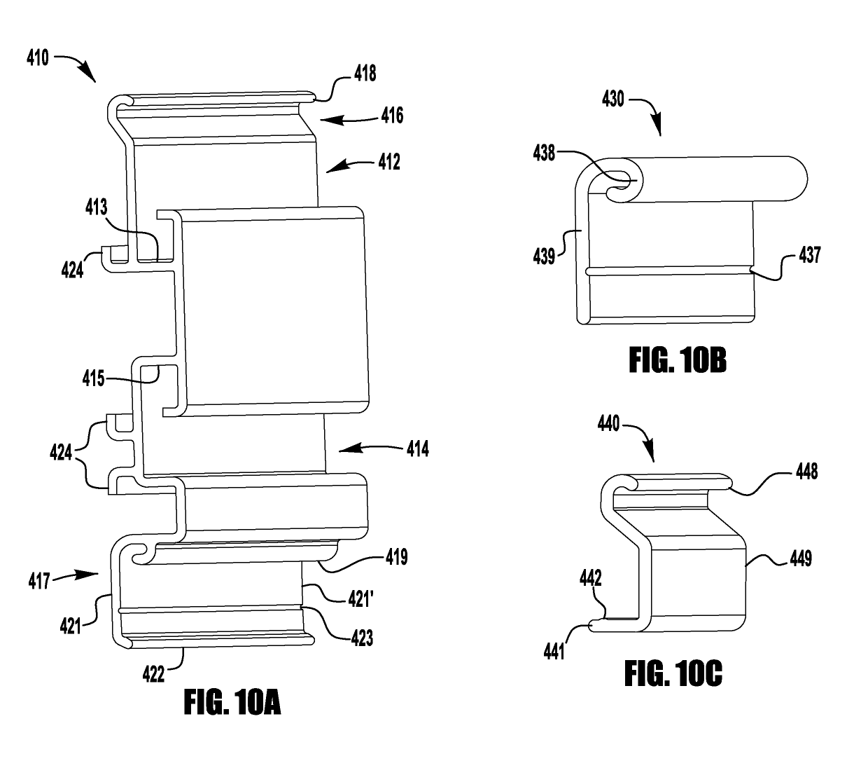

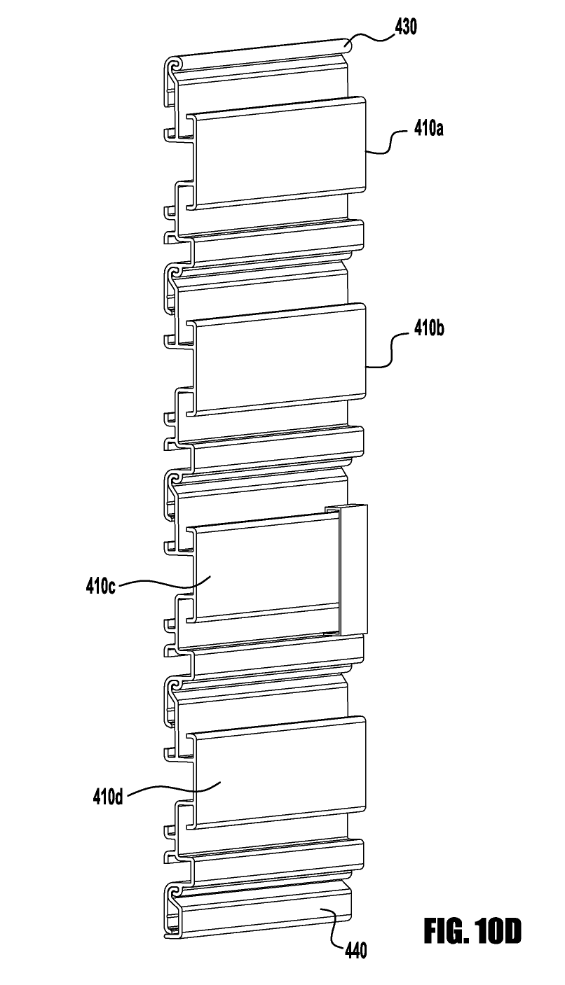

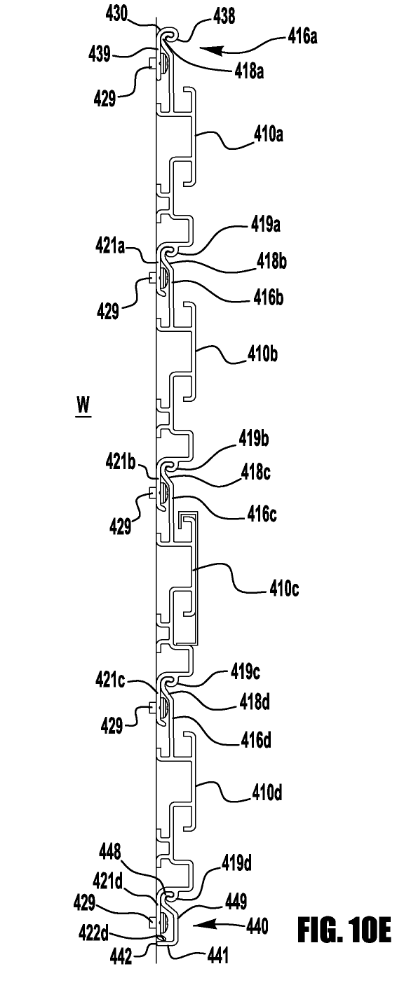

FIG. 10A illustrates an exemplary rail member 410 configured to be stacked in interlocking engagement with another rail member, which may, but need not, be substantially identical to the exemplary mounting rail member 410, as shown in FIGS. 10D and 10E. As shown, the mounting rail member 410 includes a forward oriented hook portion 418 along a first vertical end 416 of the mounting rail member 410, and a rearward oriented hook portion 419 along a second vertical end 417 of the mounting rail member 410. Extending beyond the rearward oriented hook portion 419 is an end wall or hook retaining portion 421, which serves to hold a forward oriented hook portion in pivoted interlocking engagement with the rearward oriented hook portion 419. This hook retaining portion may, but need not, be disposed on an external wall engaging portion of the rail member. Further, while the mounting rail member 410 may be fastened to a wall surface or other structure at any suitable location on the mounting rail member 410, in the illustrated embodiment, a mounting surface 421′ is provided on the end wall portion 421, such that the mounting surface and any utilized fasteners are covered by a first vertical end 416b of the second mounting rail member 410b (see FIG. 10E), thereby providing a visually seamless slatwall assembly. As shown, the mounting surface 421′ may, but need not, include a mounting groove 423 (or any other suitable fastener receiving portion) positioned to facilitate the alignment of one or more mounting fasteners 429 (see FIG. 10E). Further, the mounting rail member 410 may be provided with one or more spacer flanges 424 extending from a rear side of the mounting rail member 410, for example, to provide clearance for the hook portions 418.

According to an inventive aspect of the present application, rail members configured to be stacked in interlocking engagement, may be provided with one or more of a variety of fastening configurations, including, for example, one or more slots provided in a variety of cross-sectional shapes and orientations. In the illustrated embodiment of FIG. 10A, the mounting rail member 410 includes first and second slots 412, 414 with corresponding first and second opposed L-shaped undercuts 413, 415, which may be consistent with the slots and undercuts of the rail members 110, 210, 310, of FIGS. 6A-9D.

According to another inventive aspect of the present application, an elongated anchor rail member or starter track may be utilized to secure a first vertical end of a vertically endmost mounting rail member 410 to a wall or other surface. In one embodiment, the anchor rail member may be configured to interlock with a forward oriented hook portion along the first vertical end of the rail member. FIG. 10B illustrates an exemplary anchor rail member 430 for securing the first vertical end 416 of the mounting rail member 410 to a wall surface W (see FIG. 10E). The anchor rail member 430 includes a rearward oriented hook portion 438 extending from a mounting wall portion 439. The mounting wall portion 439 is configured to be mounted to the wall surface W, for example, by one or more mounting fasteners 429 positioned along a mounting groove 437. When the forward oriented hook portion 418a of the first mounting rail member 410a is pivoted into interlocking engagement with the rearward oriented hook portion 438 of the anchor rail member 430, the mounting wall portion 439 holds the forward hook portion 418a in interlocking engagement with the rearward hook portion 438 of the anchor rail member 430, thereby preventing vertical and perpendicular horizontal movement of the mounting rail member 410a with respect to the anchor rail member 430.

According to still another inventive aspect of the present application, an elongated cover rail member or finish trim member may be utilized to cover the exposed end wall portion of a vertically endmost rail member, for example, to cover the fasteners assembled with the end wall portion. In one embodiment, the cover rail member may be configured to interlock with a rearward oriented hook portion along the second vertical end of the rail member. FIG. 10C illustrates an exemplary cover rail member 440 for covering the second vertical end 417 of the mounting rail member 410. The cover rail member 440 includes a forward oriented hook portion 448 extending from a covering portion 449. The covering portion 449 is configured to extend over the mounting surface 421′ of the end wall portion 421 of the mounting rail member 410, for example, to cover one or more mounting fasteners 429. As shown in FIG. 10E, when the rearward oriented hook portion 419c of the mounting rail member 410d is pivoted into interlocking engagement with the forward oriented hook portion 448 of the cover rail member 440, the end wall portion 421 of the mounting rail member 410 holds the forward oriented hook portion 448 in interlocking engagement with the rearward hook portion 419d of the mounting rail member 410d, thereby preventing vertical and perpendicular horizontal movement of the cover rail member 440 with respect to the mounting rail member 410d. The cover rail member 440 may further include a retaining flange 441 configured to engage an edge 422 of the end wall portion 421 of the mounting rail member 410. The flange may include a rib 442 or other protrusion to provide a retaining interference fit between the flange 441 and the edge 422.

In an exemplary embodiment, to construct and mount a slatwall system in accordance with exemplary aspects of the present application, as shown in FIG. 10E, an anchor rail member 430 is fastened or secured to a wall surface W by mounting a mounting wall portion 439 of the anchor rail member 430 to the wall surface W using, for example, one or more mounting fasteners 429 (e.g., screws). A forward oriented hook portion 418a of a first mounting rail member 410a is engaged with or received in interlocking engagement with a rearward oriented hook portion 438 of the anchor rail member 430, for example, by sliding or pivoting the hook portions 418a, 438 into interlocking engagement with each other. When the mounting rail member is pivoted to engage end wall portion 421a with the external wall surface W, the forward oriented hook portion 418a is interlocked between the rearward oriented hook portion 438 of the anchor rail member 430 and a hook retaining portion on the mounting wall 439. This prevents lateral disengagement of the forward oriented hook portion 418a from the rearward oriented hook portion 438 upon installation. The first vertical end portion 416a of the first mounting rail member 410a covers the mounting wall 439 of the anchor rail member 430. The end wall portion 421a of the first mounting rail member 410a is then fastened to the wall surface W using one or more mounting fasteners 429. A forward oriented hook portion 418b of a second mounting rail member 410b is similarly received in interlocking engagement with a rearward oriented hook portion 419a of the first mounting rail member 410a, for example, by sliding or pivoting the hook portions 418b, 419a into interlocking engagement with each other. The first vertical end portion 416b of the second mounting rail member 410b covers the end wall portion 421a of the first mounting rail member 410a. Once the second rail member 410b is assembled with the first rail member 410a (for example, with the second rail member pivoted such that the wall engaging surfaces of the first and second rail members are substantially coplanar), an end wall portion 421b of the second mounting rail member 410b is then fastened to the wall surface W using one or more mounting fasteners 429.

One or more additional rail members (for example, third mounting rail member 410c and fourth mounting rail member 410d) may (but need not) be added using similar interlocking and mounting procedures. Finally, a forward oriented hook portion 448 of a cover rail member 440 is received in interlocking engagement with a rearward oriented hook portion 419d of the last or endmost mounting rail member 410c, for example, by sliding or pivoting the hook portions 448, 419c into interlocking engagement with each other. The covering portion 449 of the cover rail member 440 covers the end wall portion 421c of the endmost mounting rail member 410c, and the flange 441 and rib 442 engage the edge 422d of the mounting rail member 410d to more securely retain the cover rail member 440 on the mounting rail member 410d.

While the illustrated embodiment of FIG. 10E shows the anchor rail member 430 disposed at a vertically uppermost position and the cover rail member 440 disposed at a vertically lowermost position, it is to be understood that an anchor rail member may instead be disposed at a vertically lowermost position on a slatwall assembly, and a cover rail member may be assembled at a vertically uppermost position. Further, while the mounting rail member 410, anchor rail member 430, and cover rail member are shown in extruded metal (e.g., aluminum), it is to be understood that other materials (e.g., PVC) and manufacturing techniques (e.g., machining, injection molding) may be utilized.

In the exemplary rail members 110, 210, 210′, 310, 310′, 410 of FIGS. 6A-10A, the slots, undercuts, recesses, hook portions, and other such features extend longitudinally over the length of the rail member. In other embodiments, one or more of these features may extend over only a portion of the length of the rail member.

A slatwall panel or rail member, such as, for example, the exemplary rail members 110, 210, 210′, 310, 310′, 410 of FIGS. 6A-10A may be affixed to a wall by fastening the rail member directly to the wall. For example, one or more mounting holes may be drilled into the rail member, with the mounting holes being sized to receive fasteners, such as studs or mounting screws. In other embodiments, according to an inventive aspect of the present application, a wall mount member may be provided for assembly with an endmost portion of a rail member, with the wall mount member including a wall mounting arrangement, such as, for example, mounting holes for fasteners.

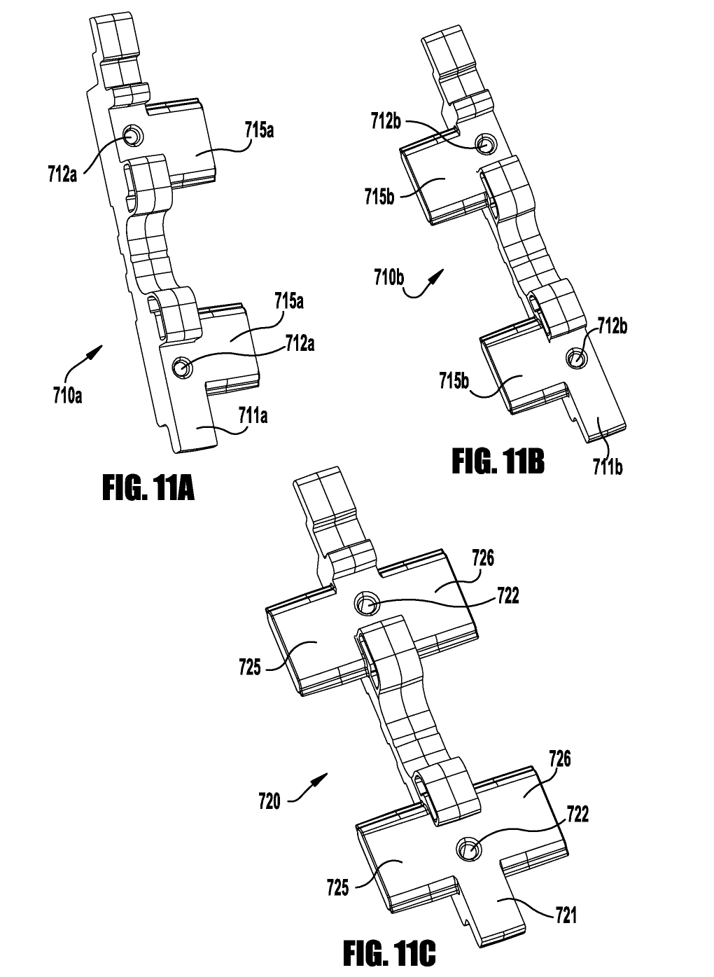

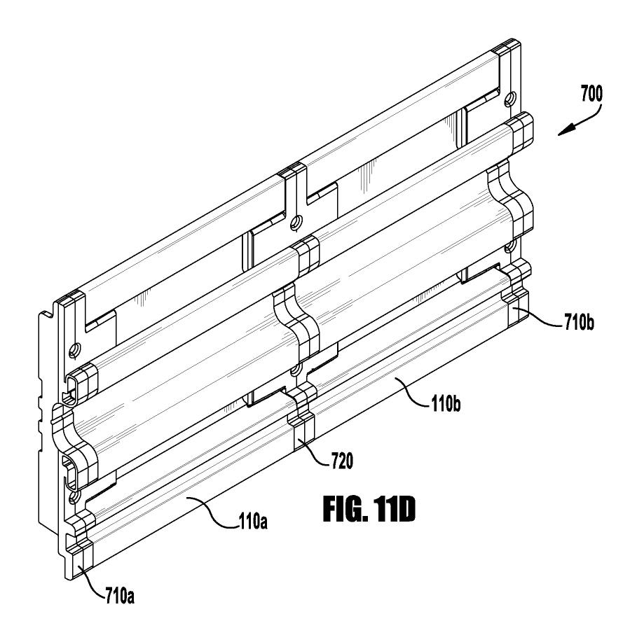

Many different configurations may be used to attach a wall mount member to an endmost portion of a rail member. In one embodiment, a wall mount member may include one or more laterally extending tabs configured to be received in corresponding slots in the rail member, such that the wall mount member may be slid into interlocking engagement with the rail member for attachment of the rail member to a wall. FIGS. 11A and 11B illustrate exemplary left and right wall mount members 710a, 710b, each having a mountable portion 711a, 711b having mounting holes 712a, 712b, and tab portions 715a, 715b sized to be received in corresponding slots in a rail member (such as, for example, first and second slots 112, 114 of the rail member 110 of FIGS. 6A and 6B). The tab portions 715a, 715b may further serve to prevent slot-mounted hardware or accessories from sliding off of the rail member. While the mountable portion may be provided in many different shapes and sizes, in one embodiment (as illustrated), the mountable portion may be provided with a profile that at least partially (and preferably substantially) matches a profile of the endmost portion of the rail member, to provide a flush appearance with the rail member. As a result, a rail member may (but need not) be provided with different wall mount members 710a, 710b for the left and right endmost portions of the rail member, as shown in the illustrated embodiment.

According to another inventive aspect of the present application, a mounting member may be configured to function as a rail joining member for aligning and joining two rail members to be mounted to a wall end-to-end. This joining member may, but need not, include a mountable portion for securing the joined rail members to a wall. Many different configurations may be used to align and join rail members in an end-to-end configuration. In one embodiment, a joining member may include opposed laterally extending tab portions configured to be received in corresponding slots in first and second rail members, such that the joining member may be slid into interlocking engagement with the first and second rail members for joining and/or aligning the first and second rail members. FIG. 11C illustrates an exemplary joining member 720 having a central portion 721 and opposed tongue portions 725, 726 sized to be received in corresponding slots in first and second rail members (such as, for example, first and second slots 112, 114 of the rail member 110 of FIGS. 6A and 6B). As shown, the central portion 721 may, but need not, be provided with one or more mounting portions, such as, for example, mounting holes 722 for receiving fasteners, to secure the joining member (and with it, the first and second rail members) to a wall. While the central portion 721 may be provided in many different shapes and sizes, in one embodiment (as illustrated), the mountable portion may be provided with a profile that at least partially (and preferably substantially) matches a profile of the endmost portions of the first and second rail members, to provide a flush appearance with the rail members. FIG. 11D illustrates an exemplary slatwall assembly 700 including first and second rail members 110a, 110b assembled with left and right wall mount members 710a, 710b and joined together by joining member 720.

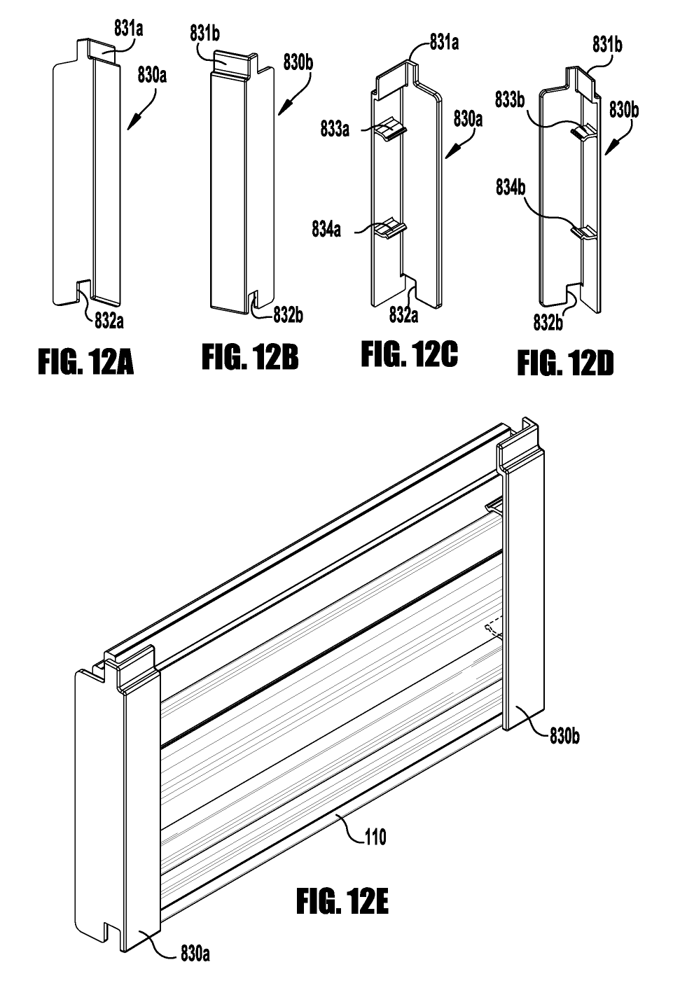

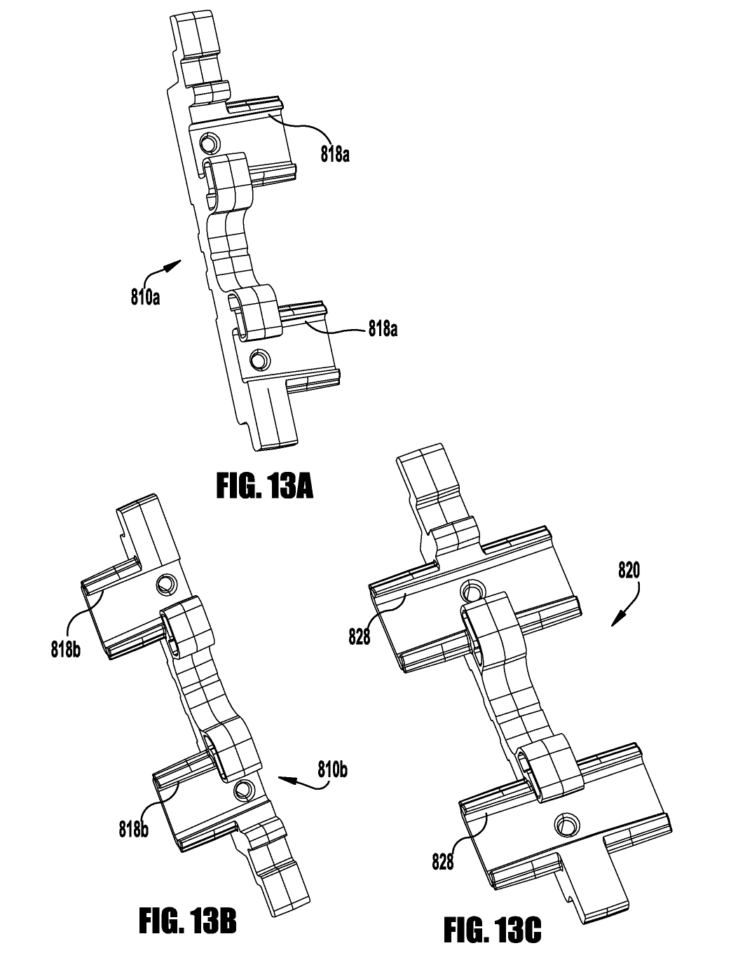

According to another aspect of the present application, one or more cap members may be provided to cover an endmost portion of a rail member, a wall mount member, a joining member, or some other portion of the wall mount system. In one embodiment, a cap member may be configured to accommodate stacking of two or more rail members, for example, as shown in (and described with reference to) the panel assembly 200 of FIG. 7. FIGS. 12A, 12B, 12C, and 12D illustrate exemplary left and right end cap members 830a, 830b, configured for use with endmost portions of the rail members 110 of FIGS. 6A and 6B. Each end cap member 830a, 830b includes a narrowed down upper portion 831a, 831b sized to fit around the vertically extending tongue 116 of a rail member 110, and sized to be received in a corresponding groove 117 of an adjacent stacked rail member 110. Each end cap member 830a, 830b further includes a lower notch portion 832a, 832b configured to align with the groove 117 of the rail member 110 for receiving the tongue 116 of an adjacent stacked rail member 110, and/or the upper narrowed portion 831a, 831b of a cap member 830a, 830b assembled with the adjacent rail member 110.

While many different configurations may be used to affix a cap member to an endmost portion of a rail member, in one embodiment, a cap member may include one or more inwardly extending flexible prongs configured to snap over a portion of the rail member, such as, for example, an overhang portion defining an undercut in a slot of the rail member. As shown in FIGS. 12C and 12D, the exemplary end cap members 830a, 830b include inwardly extending flexible prongs 833a, 834a, 833b, 834b configured to snap onto overhang portions 113′, 115′ of the rail member 110 (FIGS. 6A and 6B). FIG. 12E illustrates an exemplary rail member 110 assembled with left and right cap members 830a, 830b.

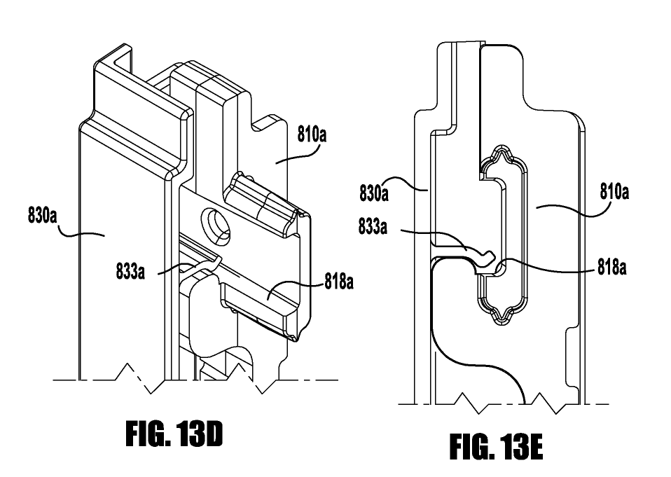

According to another inventive aspect of the present application, a wall mount member or joining member, as described herein, may be configured to receive a cap member, such as the cap members 830a, 830b of FIGS. 12A-12D. In one embodiment, a wall mount member or joining member may include a tab portion having an outward facing recess, the recess being sized and shaped to accommodate a flexible prong of a cap member. FIGS. 13A, 13B, and 13C illustrate a left wall mount member 810a, a right wall mount member 810b, and a joining member 820, respectively, having tongue recesses 818a, 818b, 828 configured to accommodate flexible prongs of a cap member (such as, for example, the flexible prongs 833a, 834a, 833b, 834b of the cap members 830a, 830b of FIGS. 12A-12D) when the cap member is assembled with the wall mount member 810a, 810b or joining member 820. FIGS. 13D and 13E illustrate a cap member 830a assembled with a left wall mount member 810a.

Other inventive features may be provided with a rail member in accordance with the present application. For example, a rail member may be configured to include a hollow portion or recess for receiving electrical wiring, for example, to supply power to electrical devices mounted to or stored on the rail member. As one example, rechargeable electrical hand tools mounted to or stored on the rail member may be connected to electrical wiring provided in or on the rail member, so that the hand tools may remain fully charged and ready for use.

A rail member configured to receive electrical wiring may be provided with a hollow portion or recess that is large enough to allow an end user to install electrical wiring (e.g., an extension cord) before or after the rail member is mounted to a wall. As one example, the rail member may be formed around the electrical wiring, or the electrical wiring may be pre-installed in a hollow portion (e.g., a hole or channel) of the rail member, such that an end user may obtain a rail member with integrated electrical wiring. As another example, a rail member may be provided with a wiring recess sized and positioned to facilitate connection with one or more electrical components mounted to the rail member, while enabling removal and/or replacement of the electrical wiring.

In one embodiment, an electrical component may be mounted to a rail member to extend at least partially across a wiring recess, for connection with electrical wiring disposed within the wiring recess. The electrical wiring may be retained in the wiring recess using many different structures and configurations, including, for example, fasteners, adhesives, cover plates, and other such components. In one embodiment, the electrical wiring is retained such that a majority of the wiring is concealed from view, for example, to protect the wiring and/or to provide a more orderly appearance for the mounting system. As one example, a sleeve or sheath may be sized to be retained in the wiring recess for enclosure of the electrical wiring. The sleeve may be provided with one or more wiring access openings through which the electrical wiring may extend to connect with one or more electrical components mounted to the rail member. While many different types of openings may be used, including, for example, holes, cutouts, or gaps in a segmented sleeve, in one embodiment, a sleeve includes a flexible seam that may be spread apart at desired locations to pass the electrical wiring therethrough, while remaining closed (e.g., adjoining or overlapping) at other locations for full enclosure of the wiring.

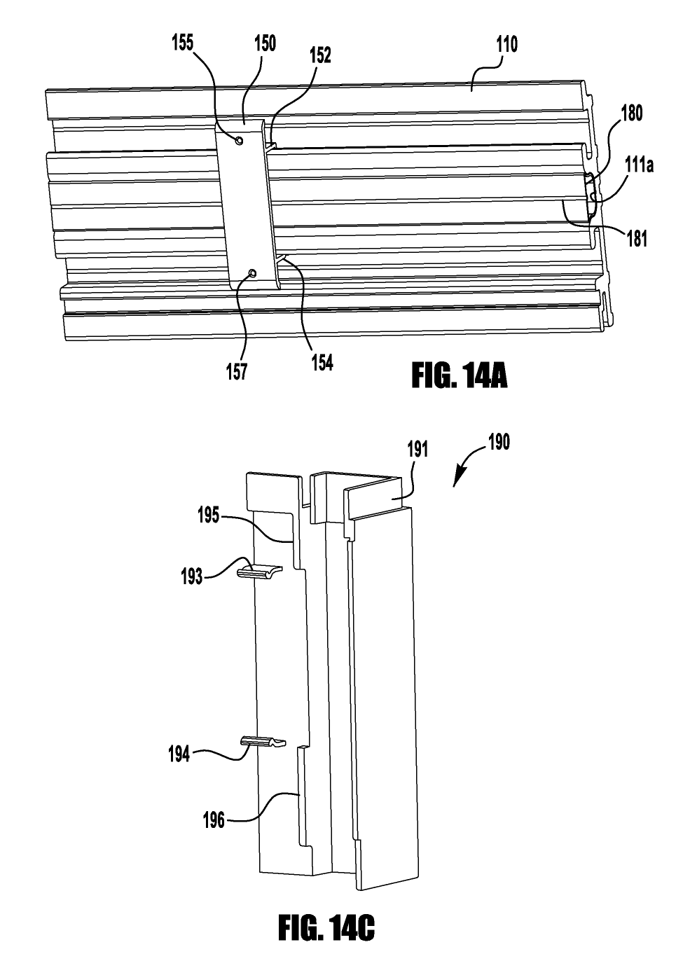

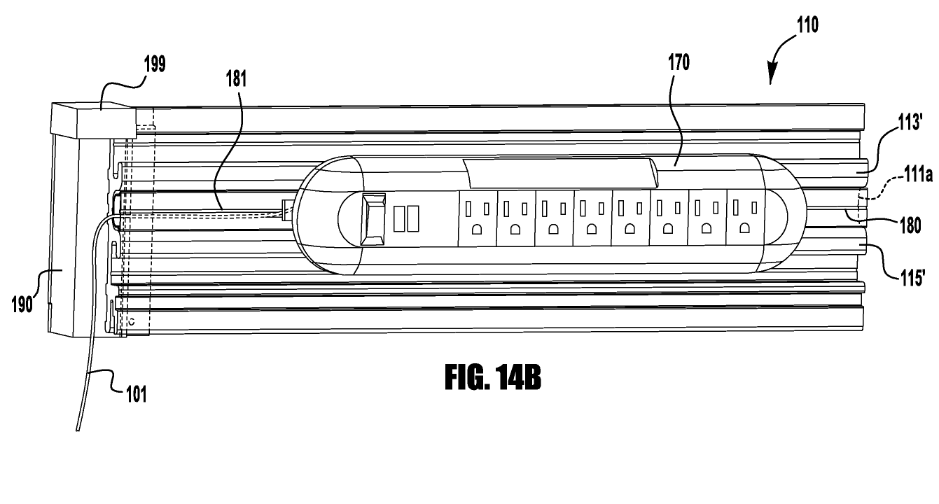

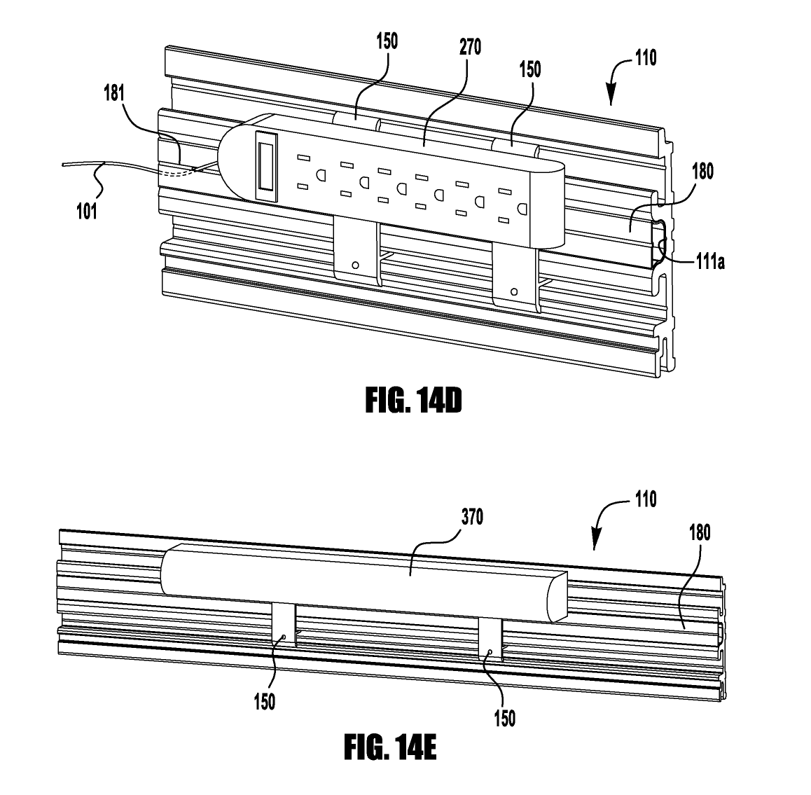

FIGS. 14A, 14B, 14D, and 14E illustrate wall mounting systems in which a rail member 110 includes a recess 111a that serves as a wiring recess for retention of electrical wiring positioned to power electrical components, such as, for example, a power strip (FIGS. 14C and 14D), a lighting fixture (FIG. 14E), or a battery charger (not shown), mounted to the rail member 110. A wiring sleeve 180 is retained in the recess 111a and may be attached to the rail member 110, for example, using adhesive tape, fasteners, or some other attachment. The exemplary sleeve 180 is constructed of a flexible, resilient material (e.g., nylon or some other thermoplastic material) and includes a flexible seam 181 extending along a front portion of the sleeve. As shown in FIG. 14B, to withdraw a portion of the electrical wiring from the sleeve 180, the flexible seam 181 may be spread open in a desired location on the sleeve 180 to extend the wiring therethrough, for example, to attach the wiring to an electrical component 170 proximate the spread open portion of the seam 181. This minimizes the amount of visible or exposed wiring, while allowing for access to the wiring at any location along the length of the sleeve 180.

Further, the mounting system may be provided with a cap member assembled to the end of the rail member, with the cap member defining a passage for retaining electrical wiring extending to the rail member (e.g., from a wall outlet or generator). FIG. 14C illustrates an exemplary cap member 190 having outer walls that define a vertical inner passage sized to accommodate electrical wiring. The exemplary cap member 190 includes inwardly extending flexible prongs 193, 194 configured to snap onto overhang portions 113′, 115′ of the rail member 110, and internal detents 195, 196 positioned to abut the edge of the rail member 110 to maintain the internal passage. The cap member 190 may further be provided with a stepped end 191 to facilitate stacking with one or more additional cap members. A plug member 199 (FIG. 14B) may be provided to cover the uppermost cap member 190. As shown in FIG. 14B, when the cap member 190 is assembled with a rail member 110 having an installed wiring sleeve 180, installed electrical wiring 101 may extend through the end cap passage and directly into the sleeve 180, thereby limiting the exposed wiring 101 on the rail to a small portion extending through the seam 181 at the electrical component (power strip 170).

As shown in FIG. 14B, an electrical component 170 may be mounted directly to the rail member 110 such that the electrical component 170 at least partially overlaps the recess 111a. The electrical component may be provided with integral hooks or retaining portions (e.g., the retaining portions 172, 174 shown in FIG. 7E) configured to engage the overhang portions 113′, 115′ of the rail member 110. In another embodiment, as shown in FIGS. 14D and 14E, the electrical component 270, 370 may be mounted to one or more brackets (which may, but need not, be consistent with the mounting bracket 150 of FIGS. 7A and 7B) configured to be secured across the recess 111a (for example, by flanges or hook portions on the bracket).

Some of the exemplary rail members disclosed herein (for example, the rail members 110, 210 of FIGS. 6A-6C and 8A and 8B include longitudinal recesses 111a, 211 that may receive an electrical wiring sleeve, as described herein. Other exemplary embodiments described herein, including, for example, the rail members 310, 410 of FIGS. 9A and 9B and 10A-10E, may likewise be provided with a longitudinal recess (not shown) for receiving an electrical wiring sleeve or similar electrical wiring retention arrangement.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred system or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A wall-mountable slatwall system for use with one or more mounting components, the system comprising:
a first rail member comprising first and second edges extending in a longitudinal direction between first and second ends, at least one wall engaging portion disposed on a rear side of the first rail member and a rearward oriented first hook portion disposed on a front side of the first rail member; and
a second rail member comprising first and second edges extending in a longitudinal direction between first and second ends, at least one wall engaging portion disposed on a rear side of the second rail member and a forward oriented second hook portion disposed along the first edge of the second rail member on a forward side of the second rail member, the second hook portion being pivotally receivable between the first hook portion and the at least one wall engaging portion of the first rail member for interlocking engagement of the first and second hook portions when the second rail member is assembled with the first rail member, such that the first rail member obstructs lateral disengagement of the second hook portion from the first hook portion;
wherein at least one of the first and second rail members includes at least one slot portion disposed on the front side and configured to engage a portion of the one or more mounting components for mounted retention of the one or more mounting components.

2. The system of claim 1, wherein the at least one wall engaging portion of the first rail member includes a fastener receiving portion for securing the first rail member to an external wall.

3. The system of claim 2, wherein the fastener receiving portion is positioned to be covered by a vertical wall portion extending from the second hook portion when the second rail member is assembled with the first rail member.

4. The system of claim 3, wherein the vertical wall portion is laterally offset from the second hook portion to provide clearance for a fastener assembled with the fastener receiving portion of the first rail member.

5. The system of claim 1, wherein the second rail member further comprises a rearward oriented third hook portion disposed on the front side of the second rail member.

6. The system of claim 5, further comprising a third rail member including first and second edges extending in a longitudinal direction between first and second ends, at least one wall engaging portion disposed on a rear side of the third rail member and a forward oriented fourth hook portion disposed along the first edge of the third rail member on a front side of the third rail member, the fourth hook portion being pivotally receivable between the third hook portion and the at least one wall engaging portion of the second rail member for interlocking engagement of the fourth hook portion with the third hook portion when the third rail member is assembled with the second rail member, such that the second rail member obstructs lateral disengagement of the fourth hook portion from the third hook portion.

7. The system of claim 6, wherein at least two of the first, second, and third rail members are substantially identical.

8. The system of claim 1, wherein the second rail member comprises first and second slot portions disposed on the second side of the second rail member and configured to engage first and second mounting portions of the one or more mounting components for mounted retention of the one or more mounting components.

9. The system of claim 8, wherein the first slot portion of the second rail member comprises an undercut extending away from the first edge of the second rail member, and the second slot portion of the second rail member comprises an undercut extending away from the second edge of the second rail member.

10. The system of claim 1, wherein the second rail member includes a rearward oriented retaining flange on the second edge of the second rail member, the retaining flange being configured to engage a corresponding forward oriented projection on the first rail member to secure the second rail member against pivoting rotation with respect to the first rail member.

11. The system of claim 1, wherein at least one of the first and second rail members further comprises a recess extending in a longitudinal direction between the first and second ends, and an electrical wire retaining sleeve securely retained in recess, the sleeve including a longitudinal seam disposed in a front portion of the sleeve, with at least a portion of the sleeve being flexible to permit spreading of the seam for extension of electrical wiring therethrough for connection with an electrically powered component mounted to the at least one of the first and second rail members.

12. The system of claim 11, further comprising a cap member assembled to one of the first and second ends of the at least one of the first and second rail members, the cap member defining a vertical passage configured to retain a portion of the electrical wiring and to allow the wiring to extend into the sleeve.

13. A method of preparing a wall mounted slatwall, the method comprising:
securing a wall engaging portion on a rear side of a first rail member to an external wall surface;
engaging a forward oriented second hook portion on a front side of a second rail member with a rearward oriented first hook portion on a front side of the first rail member; and
pivoting the second rail member to engage a wall engaging portion on a rear side of the second rail member with the external wall surface, such that the second hook portion is interlocked between the first hook portion and a hook retaining portion of the first rail member;
wherein at least one of the first and second rail members defines at least one slot portion disposed on the front side and configured to receive one or more mounting components for mounted retention of the one or more mounting components.

14. The method of claim 13, wherein securing the wall engaging portion of the first rail member to the external wall surface comprises installing a fastener through a fastener receiving portion on the wall engaging portion of the first rail member.

15. The method of claim 14, wherein pivoting the second rail member to engage the wall engaging portion of the second rail member with the external wall surface causes a vertical wall portion extending from the forward oriented hook portion of the second rail member to cover the fastener.

16. The method of claim 13, further comprising engaging a forward oriented fourth hook portion of a third rail member with a rearward oriented third hook portion of the second rail member, and pivoting the third rail member to engage a wall engaging portion of the third rail member with the external wall surface, such that the fourth hook portion is interlocked between the third hook portion and a hook retaining portion of the second rail member.

17. The method of claim 16, further comprising securing the wall engaging portion of the second rail member to the external wall surface with a second fastener.

18. The method of claim 17, wherein pivoting the third rail member to engage the wall engaging portion of the third rail member with the external wall surface causes a vertical wall portion extending from the forward oriented hook portion of the third rail member to cover the second fastener.

19. A slatwall mounting system for electrically powered components, the system comprising:
a rail member comprising first and second edges extending in a longitudinal direction between first and second ends, a rear side configured to engage an external wall surface, and a front side having a first slot portion proximate the first edge and including an undercut extending away from the first edge, a second slot portion proximate the second edge and including an undercut extending away from the second edge, and a recess disposed between the first and second slot portions and extending between the first and second ends of the rail member; and
an electrical wire retaining sleeve securely retained in the rail member recess, the sleeve including a longitudinal seam disposed in a front portion of the sleeve, with at least a portion of the sleeve being flexible to permit spreading of the seam for extension of electrical wiring therethrough for connection with an electrically powered component mounted to the rail member.

20. The system of claim 19, further comprising a cap member assembled to one of the first and second ends of the rail member, the cap member defining a vertical passage configured to retain a portion of the electrical wiring and to allow the wiring to extend into the sleeve.
